(19) United States
(12) Patent Application Publication
(10) Pub. No.: US 2010/0246084 A1
(43) Pub. Date: Sep. 30, 2010

(54) Control circuit

(76) Inventors: Chia-Han Chan, Tu-Cheng City (TW); Nan-Sheng Chang, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/384,090

(22) Filed: Mar. 30, 2009

(51) Int. Cl. H02H 5/04

(52) U.S. Cl. 361/103

(57) ABSTRACT

A control circuit includes a voltage-dividing resistor connected to a voltage input terminal, at least one thermal breaker series-connected between the voltage-dividing resistor and the ground and disposed near one corresponding battery, and an output terminal drawn forth from a connection location of the thermal breaker and the voltage-dividing resistor and adapted to be connected with a protective circuit. The thermal breaker breaks according to the temperature of the corresponding battery, and then the output terminal transmits different protective signals to the protective circuit according to the working state of the thermal breaker so as to make the protective circuit protect the battery based on the protective signals. Therefore, the control circuit of the present invention is relatively simpler and occupies a relatively smaller space so that can meet the demand of both miniaturization and low cost of electronic products.

### BACKGROUND OF THE INVENTION

1. Field of the Invention

The present invention generally relates to a control circuit, and more particularly to a control circuit for protecting a battery.

2. The Related Art

At present, rechargeable batteries are widely used in many electronic products as a power supply. Accordingly, it is necessary to use a charging control circuit to charge/discharge the battery. The charging control circuit includes a control circuit for generating a protective signal according to a temperature of the battery, and a protective circuit for controlling charging/discharging of the battery based on the protective signal from the control circuit so as to protect the battery from being overcharged/over-discharged.

Referring to FIG. 2, a traditional control circuit 1′ includes a first thermistor T1, a second thermistor T2, a first comparator U1, a second comparator U2 and an OUTPUT terminal. The first comparator U1 is connected between the first thermistor T1 and the OUTPUT terminal, the second comparator U2 is connected between the second thermistor T2 and the OUTPUT terminal, and the OUTPUT terminal is connected with the protective circuit (not shown). The first thermistor T1 and the second thermistor T2 are respectively disposed near one rechargeable battery (not shown). Under the normal condition, the OUTPUT terminal of the control circuit 1′ outputs a low level signal to the protective circuit. On the contrary, if the temperature of any battery rises due to the overcharging/over-discharging, then the OUTPUT terminal will output a high level signal. For example, if the temperature of the battery near the first thermistor T1 rises on account of the overcharging or over-discharging, then the resistance of the first thermistor T1 will increase on account of the risen temperature so that causes the voltage on the first thermistor T1 increased accordingly. As a result, the first comparator U1 outputs a higher voltage that causes the high level signal to be output by the OUTPUT terminal of the control circuit 1′. Then, the protective circuit interrupts the charging/discharging of the battery in the case where the high level signal is received by the protective circuit so as to protect the battery.

However, the foregoing control circuit 1′ is so complicated that occupies a relatively larger space and takes a relatively higher cost. Therefore, it is difficult to meet the demand of both miniaturization and low cost of the electronic products.

### SUMMARY OF THE INVENTION

An object of the present invention is to provide a control circuit adapted for transmitting protective signals to a protective circuit so as to make the protective circuit protect a battery based on the protective signals. The control circuit includes a voltage-dividing resistor connected to a voltage input terminal, at least one thermal breaker series-connected between the voltage-dividing resistor and the ground and disposed near one corresponding battery, and an output terminal drawn forth from a connection location of the thermal breaker and the voltage-dividing resistor and adapted to be connected with the protective circuit. Wherein the thermal breaker can be broken according to the temperature of the corresponding battery, and then the output terminal transmits different protective signals to the protective circuit according to the working state of the thermal breaker.

As described above, the control circuit of the present invention protects the battery by way of the thermal breaker instead of thermistors and comparators of the related art. Therefore, the control circuit of the present invention is relatively simpler and occupies a relatively smaller space so that can meet the demand of both miniaturization and low cost of electronic products.

### BRIEF DESCRIPTION OF THE DRAWINGS

The present invention will be apparent to those skilled in the art by reading the following description, with reference to the attached drawings, in which:

FIG. 1 is a circuitry of a control circuit of the present invention; and

FIG. 2 is a circuitry of a traditional control circuit.

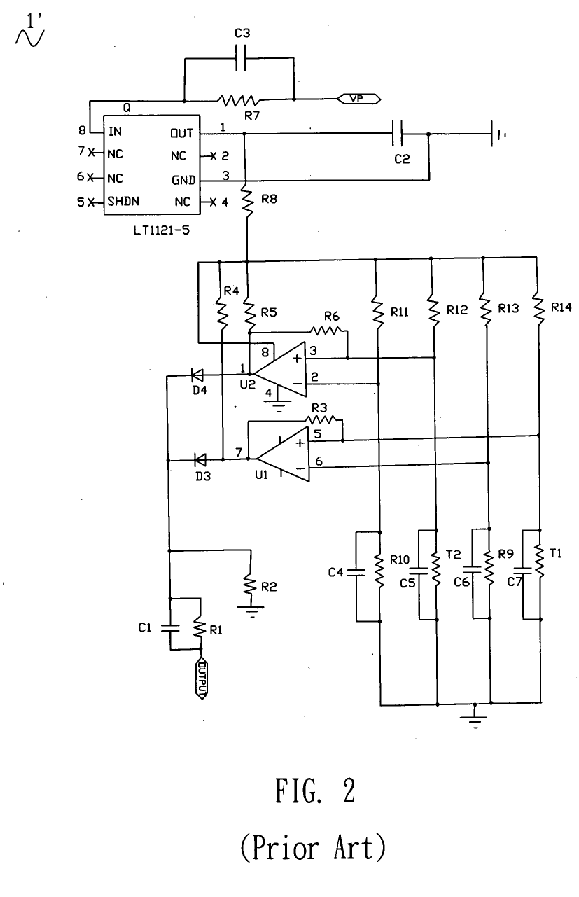

### DETAILED DESCRIPTION OF THE PREFERRED EMBODIMENT

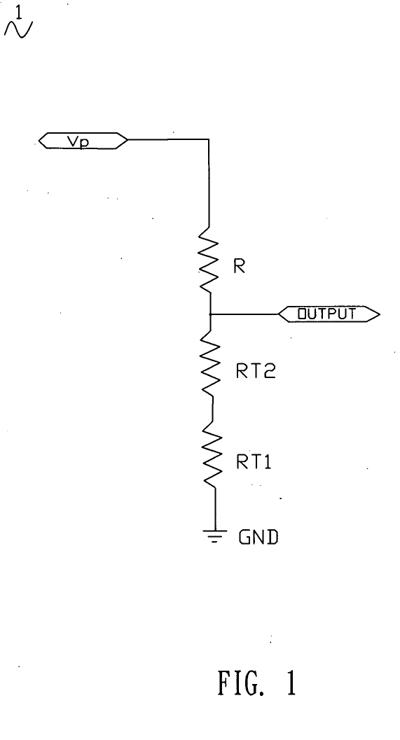

With reference to FIG. 1, a control circuit 1 according to the present invention is shown. The control circuit 1 can generate and transmit a protective signal to a protective circuit (not shown) according to a temperature of a battery (not shown), wherein the protective circuit can control charging/discharging of the battery based on the protective signal from the control circuit so as to protect the battery from being overcharged/over-discharged. The control circuit 1 includes a first thermal breaker RT1, a second thermal breaker RT2, a voltage-dividing resistor R and an OUTPUT terminal. The second thermal breaker RT2 is series-connected between the voltage-dividing resistor R and the first thermal breaker RT1. The other terminal of the voltage-dividing resistor R is connected to a voltage input terminal Vp, and the other terminal of the first thermal breaker RT1 is connected to ground. The OUTPUT terminal is drawn forth from a connection location of the second thermal breaker RT2 and the voltage-dividing resistor R, and further connected to the protective circuit so as to transmit the protective signal thereto. The first thermal breaker RT1 and the second thermal breaker RT2 are disposed near corresponding batteries respectively.

In the embodiment, the environment temperature under which the battery near the first thermal breaker RT1 is located relatively lower than the environment temperature under which the other battery near the second thermal breaker RT2 is located. The temperature capable of making the first thermal breaker RT1 broken is 60 degrees centigrade, and the temperature capable of making the second thermal breaker RT2 broken is 70 degrees centigrade.

Under the normal condition, the OUTPUT terminal of the control circuit 1 outputs a low level signal to the protective circuit. On the contrary, if the temperature of any battery rises to cause the corresponding thermal breaker RT1/RT2 broken due to the overcharging/over-discharging, then the OUTPUT terminal will output a high level signal to the protective circuit. For example, if the temperature of the battery near the first thermal breaker RT1 rises to 60 degrees centigrade on account of the overcharging or over-discharging, then the first thermal breaker RT1 will be broken that causes the high level signal output by the OUTPUT terminal of the control circuit 1. Then, the protective circuit interrupts the charging/discharging of the battery in the case where the high level signal is received by the protective circuit so as to protect the battery. The working rule of the second thermal breaker RT2 is the same with the first thermal breaker RT1, so it is not gone into details any more here.

As described above, the control circuit 1 of the present invention protects the batteries by way of the thermal breakers RT1, RT2, instead of thermistors T1, T2 and comparators U1, U2 of the related art. Therefore, the control circuit 1 of the present invention is relatively simpler and occupies a relatively smaller space so that can meet the demand of both miniaturization and low cost of electronic products.

What is claimed is:

1. A control circuit adapted for transmitting protective signals to a protective circuit so as to make the protective circuit protect a battery based on the protective signals, the control circuit comprising:
a voltage-dividing resistor connected to a voltage input terminal;
at least one thermal breaker series-connected between the voltage-dividing resistor and the ground, and disposed near one corresponding battery, wherein the thermal breaker breaks according to the predetermined temperature of the corresponding battery; and
an output terminal drawn forth from a connection location of the thermal breaker and the voltage-dividing resistor, the output terminal being adapted to be connected with the protective circuit for transmitting different protective signals to the protective circuit according to the working state of the thermal breaker.
